(19) United States
(12) Patent Application Publication
(10) Pub. No.: US 2023/0138408 A1
(43) Pub. Date: May 4, 2023

(54) COMMUNICATION INTERFACE ADAPTER, METHOD FOR DYNAMIC PID ASSIGNMENT, AND METHOD FOR AUTOMATICALLY DIAGNOSING PERIPHERAL DEVICE AND RECOVERING PERIPHERAL DEVICE FOUND TO BE IN ABNORMAL OPERATION

(71) Applicant: FLYTECH TECHNOLOGY CO., LTD., Taipei City (TW)

(72) Inventors: Tai-Seng Lam, Taipei City (TW); Li-Chun Chou, Taipei City (TW); Shui-Chin Tsai, Taipei City (TW); Chien-Lin Su, Taipei City (TW)

(21) Appl. No.: 17/710,590

(22) Filed: Mar. 31, 2022

(30) Foreign Application Priority Data
Oct. 29, 2021 (TW) 110140288

(51) Int. Cl. G06F 13/38; G06F 13/42

(52) U.S. Cl. CPC G06F 13/382; G06F 13/4282; G06F 2213/0042

(57) ABSTRACT

A communication interface adapter is provided to include a first communication interface to be electrically connected to a computer device, a second communication interface to be electrically connected to the peripheral device, a microcontroller, a communication interface hub electrically connected to the first communication interface and the microcontroller, and a switch unit electrically connected between the communication interface hub and the second communication interface. The switch unit is controlled by the microcontroller to make or break connection between the communication interface hub and the second communication interface.

### CROSS-REFERENCE TO RELATED APPLICATION

This application claims priority of Taiwanese Invention Patent Application No. 110140288, filed on Oct. 29, 2021.

### FIELD

The disclosure relates to an adapter, and more particularly to a communication interface adapter that is electrically connected between a computer device and a peripheral device for controlling signal transmission between the computer device and the peripheral device.

### BACKGROUND

Computer systems that are used in retail, transportation and public areas are usually composed of a terminal computer and one or more peripheral devices, such as a printer, a barcode scanner, a webcam, a programmable keyboard, etc. Most of these peripheral devices are connected to the terminal computer using communication interfaces, for example but not limited to, the universal serial bus (USB). The terminal computer is usually installed with various application programs that are self-developed by a manufacturer of the terminal computer or developed by independent software developers for commercial or industrial applications. When an application program executed by the terminal computer needs to control one of the peripheral devices, the application program needs an application programming interface (API) provided by a supplier of the peripheral device to command the peripheral device to perform power on, power off, restart, or other actions.

However, the above practice will make the program application unable to support some relevant peripheral devices on the market because supportability of the program application depends on whether the suppliers of the peripheral devices have provided corresponding APIs to the developer of the application program. An application program can only command those of the peripheral devices, the suppliers of which have provided corresponding APIs to the developer of the application program, to perform desired actions such as power on, power off or restart.

### SUMMARY

Therefore, an object of the disclosure is to provide a communication interface adapter (for example but not limited to, a USB adapter) that can control signal transmission from a computer device to a peripheral device, so a software program of the computer device can control, through the communication interface adapter, any peripheral device that adopts the same communication interface as the communication interface adapter, without being limited to whether a supplier of the peripheral device has provided a corresponding API for use by a developer of the software program.

According to the disclosure, the communication interface adapter includes a first communication interface to be electrically connected to the computer device, a second communication interface to be electrically connected to the peripheral device, a microcontroller, a communication interface hub electrically connected to the first communication interface and the microcontroller, and a switch unit electrically connected between the communication interface hub and the second communication interface. The switch unit is controlled by the microcontroller to make or break connection between the communication interface hub and the second communication interface.

Another object of the disclosure is to provide a method of dynamic product identification (PID) assignment, which is applicable when a computer device is connected to multiple communication interface adapters. The method can solve a problem that may occur when the communication interface adapters have the same default PID that are assigned during production. The problem may cause an application program executed by the computer device to submit instructions to wrong peripheral devices. In the method, each of the communication interface adapters includes a first communication interface electrically connected to the computer device, a second communication interface electrically connected to a peripheral device, a microcontroller storing a PID of the communication interface adapter, a communication interface hub electrically connected to the first communication interface and the microcontroller, and a switch unit electrically connected between the communication interface hub and the second communication interface. The switch unit is controlled by the microcontroller to make or break connection between the communication interface hub and the second communication interface.

According to the disclosure, the method includes steps of: by the computer device, reading a peripheral device list that is stored in the computer device, the peripheral device list containing the PID of each of the communication interface adapters; by an identification module of the computer device, obtaining the PIDs of the communication interface adapters based on the peripheral device list, and, upon determining that the PIDs of at least two of the communication interface adapters are identical, assigning a replacement PID which is different from the PIDs of said the communication interface adapters, to one of the at least two of the communication interface adapters through a control module executed by the computer device, so as to replace the PID stored in said one of the at least two of the communication interface adapters with the replacement PID; by the computer device, updating the peripheral device list by using the replacement PID to replace the PID of said one of the at least two of the communication interface adapters contained in the peripheral device list; and by the identification module, recording, based on the peripheral device list thus updated and with respect to each peripheral device among those of the peripheral devices that are each connected to one of the communication interface adapters, a correspondence between the peripheral device and the communication interface adapter in a correspondence table of the computer device.

Yet another object of the disclosure is to provide a method for automatically diagnosing a peripheral device and, when the peripheral device is found to be in abnormal operation, recovering the peripheral device. In the method, a computer is provided to be connected to a plurality of communication interface adapters, each of which includes a first communication interface electrically connected to the computer device, a second communication interface electrically connected to a peripheral device, a microcontroller storing a PID of the communication interface adapter, a communication interface hub electrically connected to the first communication interface and the microcontroller and a switch unit electrically connected between the communication interface hub and the second communication interface. The switch unit is controlled by the microcontroller to make or break connection between the communication interface hub and the second communication interface.

According to the disclosure, the method includes steps of: by the computer device, reading a peripheral device list that is stored in the computer device, wherein the peripheral device list contains the PIDs of the communication interface adapters, and device information of the peripheral devices that are connected to the communication interface adapters; by the computer device, establishing a correspondence table that records, for each of the communication interface adapters, a correspondence between the communication interface adapter and the peripheral device that is connected to the communication interface adapter; by a diagnosis module of the computer device, periodically monitoring a status of each of the peripheral devices that is recorded in the correspondence table; upon determining that one of the peripheral devices is operating abnormally, by the diagnosis module, finding out, based on the correspondence table, one of the communication interface adapters that is connected to the peripheral device which is operating abnormally, and transmitting, through a control module executed by the computer device to said one of the communication interface adapters, a control signal that includes a reset instruction and a computer-provided PID identical to the PID of said one of the communication interface adapters; and upon receiving the control signal and determining that the computer-provided PID is identical to the PID stored in said one of the communication interface adapters, by said one of the communication interface adapters, controlling, based on the reset instruction, the peripheral device that is connected to said one of the communication interface adapters and that is operating abnormally to restart.

### BRIEF DESCRIPTION OF THE DRAWINGS

Other features and advantages of the disclosure will become apparent in the following detailed description of the embodiment(s) with reference to the accompanying drawings, of which:

FIG. 1 is a block diagram illustrating an embodiment of a communication interface adapter according to the disclosure;

FIG. 2 is a block diagram illustrating that a computer device is electrically connected to two peripheral devices respectively through two communication interface adapters of this embodiment;

FIG. 3 is a flow chart illustrating steps of an embodiment of a method of dynamic product identification (PID) assignment;

FIG. 4 is a block diagram illustrating that the computer device is connected to three communication interface adapters having the same PID;

FIG. 5 is a block diagram illustrating that one of the communication interface adapters is assigned a new PID;

FIG. 6 is a block diagram illustrating that another one of the communication interface adapters is assigned another new PID;

FIG. 7 is block diagram illustrating that three peripheral devices are connected to the computer device through the communication interface adapters, and two peripheral devices are connected to the computer device without a communication interface adapter in between; and

FIG. 8 is a flow chart illustrating steps of an embodiment of a method for automatically diagnosing a peripheral device, and recovering the peripheral device when the peripheral device is found to be in abnormal operation.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

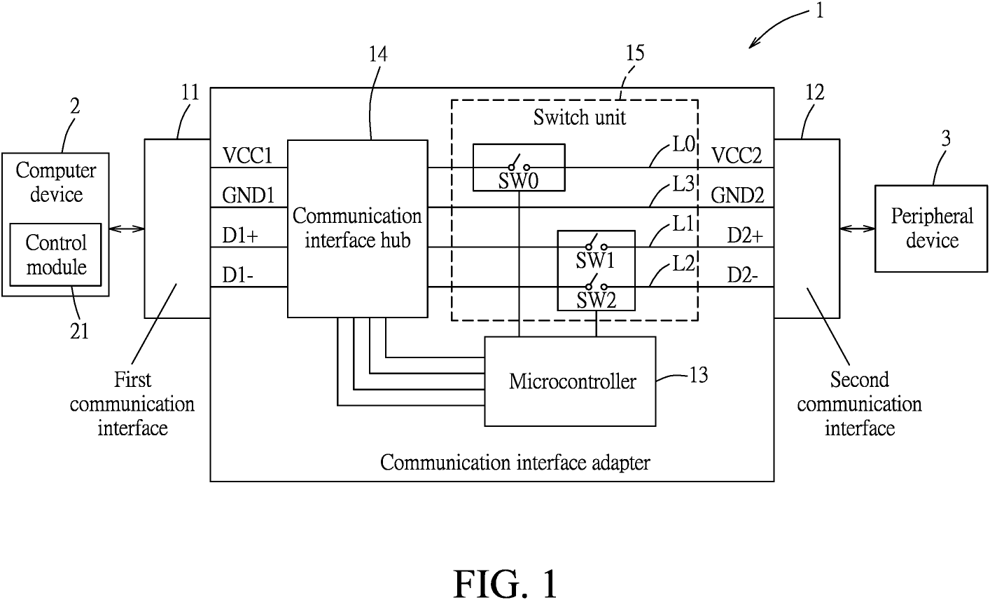

Referring to FIG. 1, an embodiment of a communication interface adapter 1 according to this disclosure is shown to be adapted to control signal transmission between a computer device 2 and a peripheral device 3. In this embodiment, the communication interface adapter 1 is exemplified as a universal serial bus (USB) adapter whose communication interface is a USB interface (i.e., an interface compliant with the USB standard), but this disclosure is not limited in this respect. The communication interface adapter 1 is adapted to be connected to a computer device 2 and a peripheral device 3 (e.g., a USB device whose communication interface is the USB interface), and includes a first communication interface 11 (e.g., a USB connector) that is electrically connected to the computer device 2, a second communication interface 12 (e.g., a USB connector) that is electrically connected to the peripheral device 3, a microcontroller 13, a communication interface hub 14 (e.g., a USB hub) that is electrically connected to the first connector 11 and the microcontroller 13, and a switch unit 15 that is electrically connected between the communication interface hub 14 and the second communication interface 12. The switch unit 15 is electrically connected to the microcontroller 13, and is controlled by the microcontroller 13 to make or break some electrical connections between the communication interface hub 14 and the second communication interface 12.

The microcontroller 13 stores a product identification (PID) (referred to as “controller-stored PID”) of the communication interface adapter 1. The communication interface hub 14 receives, from the computer device 2, a first communication interface control signal (referred to as “first control signal” hereinafter) that contains a PID (referred to as “computer-provided PID”) and a reset instruction, and transmits the first control signal to the microcontroller 13. Upon receipt of the first control signal and upon determining that the computer-provided PID is identical to the controller-stored PID (which confirms that the communication interface adapter 1 is the intended recipient of the first control signal), the microcontroller 13 controls operation of the switch unit 15 based on the reset instruction included in the first control signal, so as to break at least one of the electrical connections between the communication interface hub 14 and second communication interface 12 and then re-establish the same in order to restart the peripheral device 3 that is electrically connected to the communication interface adapter 1.

The first communication interface 11 includes a power terminal VCC1, a ground terminal GND1 and at least one data signal terminal. The second communication interface 12 includes a power terminal VCC2, a ground terminal GND2 and at least one data signal terminal. In this embodiment, each of the first communication interface 11 and the second communication interface 12 is exemplified as a USB connector, and thus includes two data signal terminals (referred to as a first signal terminal D1+ and a second signal terminal D1- for the first communication interface 11, and as a first signal terminal D2+ and a second signal terminal D2- for the second communication interface 12), but this disclosure is not limited in this respect. The communication interface hub 14 is electrically connected to the power terminal VCC2, the first signal terminal D2+, the second signal terminal D2-and the ground terminal GND2 respectively through a power signal path L0, a first signal path L1, a second signal path L2 and a ground signal path L3. The switch unit 15 includes a power switch SW0, a first signal switch SW1 and a second signal switch SW2. The power switch SW0 is disposed on the power signal path L0, and is controlled by the microcontroller 13 to make or break signal transmission on the power signal path L0. The first signal switch SW1 is disposed on the first signal path L1, and is controlled by the microcontroller 13 to make or break signal transmission on the first signal path L1. The second signal switch SW2 is disposed on the second signal path L2, and is controlled by the microcontroller 13 to make or break signal transmission on the second signal path L2.

Based on the above-mentioned configuration, a power signal outputted by the computer device 2 will be supplied to the peripheral device 3 through the first communication interface 11, the communication interface hub 14, the power signal path L0 and the second communication interface 12 when the power switch SW0 is in a conducting state, and a communication interface signal (e.g., a USB signal) outputted by the computer device 2 will be provided to the peripheral device 3 through the first communication interface 11, the communication interface hub 14, the first and second signal paths L1, L2, and the second communication interface 12 when the first and second signal switches SW1, SW2 are in the conducting state, so operation of the peripheral device 3 can be controlled by the computer device 2. In addition, the power signal and the communication interface signal are also transmitted to the microcontroller 13 through the communication interface hub 14 and signal lines between the communication interface hub 14 and the microcontroller 13, as shown in FIG. 1.

When a processor (e.g., a central processing unit (CPU), not shown) of the computer device 2 executes a control module 21 (e.g., a software program installed in the computer device 2) to reset the peripheral device 3 that is electrically connected to the communication interface adapter 1, the control module 21 generates the first control signal, and the reset instruction contained in the first control signal requests that a reset action be performed with respect to the power signal (i.e., stopping supply of the power signal and then resupplying the power signal to the peripheral device 3). Then, the control module 21 employs a driver program (e.g., a USB driver) that is installed or built in an operating system of the computer device 2 to transmit the first control signal to the microcontroller 13 through the first communication interface 11 and the communication interface hub 14 of the communication interface adapter 1. Upon determining that the reset instruction contained in the first control signal requests that the reset action be performed with respect to the power signal and that the computer-provided PID is identical to the controller-stored PID, the microcontroller 13 turns the power switch SW0 off and then on, so the power signal supplied to the peripheral device 3 is temporarily interrupted and then recovered, so as to restart the peripheral device 3. As a result, the peripheral device 3 is reset after restarting.

In another case where the peripheral device 3 that is electrically connected to the communication interface adapter 1 is powered by another power source instead of by the computer device 2 (for example, voltages required by some devices, such as a printer, may be higher than a voltage that can be provided through an USB interface), when the computer device 2 executes the control module 21 to reset the peripheral device 3, the reset instruction of the first control signal generated by the control module 21 may request that a reset action be performed with respect to the communication interface signal transmitted to the peripheral device 3 (i.e., stopping transmission of the communication interface signal and then retransmitting the same to the peripheral device 3). Upon receipt of the first control signal and upon determining that the reset instruction included in the first control signal requests that the reset action be performed with respect to the communication interface signal transmitted to the peripheral device 3 and that the computer-provided PID is identical to the controller-stored PID, the microcontroller 13 turns the first signal switch SW1 and the second signal switch SW2 off simultaneously and then on simultaneously, so as to restart the peripheral device 3, making the peripheral device 3 receive the communication interface signal through the first signal path L1 and the second signal path L2 again.

In this embodiment, if the peripheral device 3 is powered by the computer device 2, the first signal switch SW1 and the second signal switch SW2 may be omitted from the communication interface adapter 1 that is electrically connected to the peripheral device 3 because restarting the peripheral device 3 can be done by controlling only the power switch SW0; if the power of the peripheral device 3 is not supplied by the computer device 2, the power switch SW0 may be omitted from the communication interface adapter 1 that is electrically connected to peripheral device 3 because restarting the peripheral device 3 can be done by controlling only the first signal switch SW1 and the second signal switch SW2.

Therefore, when an application program developed by an independent software developer demands to restart a peripheral device 3 but the supplier of the peripheral device 3 did not provide an API to the software developer, the application program may be configured to include the control module 21, so the computer device 2 can execute the control module 21 to enable the application program to restart the peripheral device 3 through the communication interface adapter 1 that interconnects the computer device 2 and the peripheral device 3.

In this embodiment, when the microcontroller 13 detects that the communication interface adapter 1 is being electrically connected to the computer device 2 (e.g., detecting receipt of the power signal from the computer device 2), the microcontroller 13 automatically controls the power switch SW0, the first signal switch SW1 and the second signal switch SW2 to be in the conducting state, so as to ensure that the peripheral device 3 is electrically connected to the computer device 2 through the communication interface adapter 1 when the peripheral device 3 is electrically connected to the communication interface adapter 1.

In a case that the microcontroller 13 supports a monitoring mechanism, such as a watchdog mechanism (e.g., including a watchdog timer), the monitoring mechanism may issue a restart signal to the microcontroller 13 upon detecting that a main program that is being executed by the microcontroller 13 has an error, so as to restart the microcontroller 13 to recover the microcontroller 13 to a normal operation state. In order to ensure that the peripheral device 3 is electrically connected to the computer device 2 after the microcontroller 13 of the communication interface adapter 1 restarts, the microcontroller 13 is configured to automatically control the power switch SW0, the first signal switch SW1 and the second signal switch SW2 to be in the conducting state when the microcontroller 13 restarts.

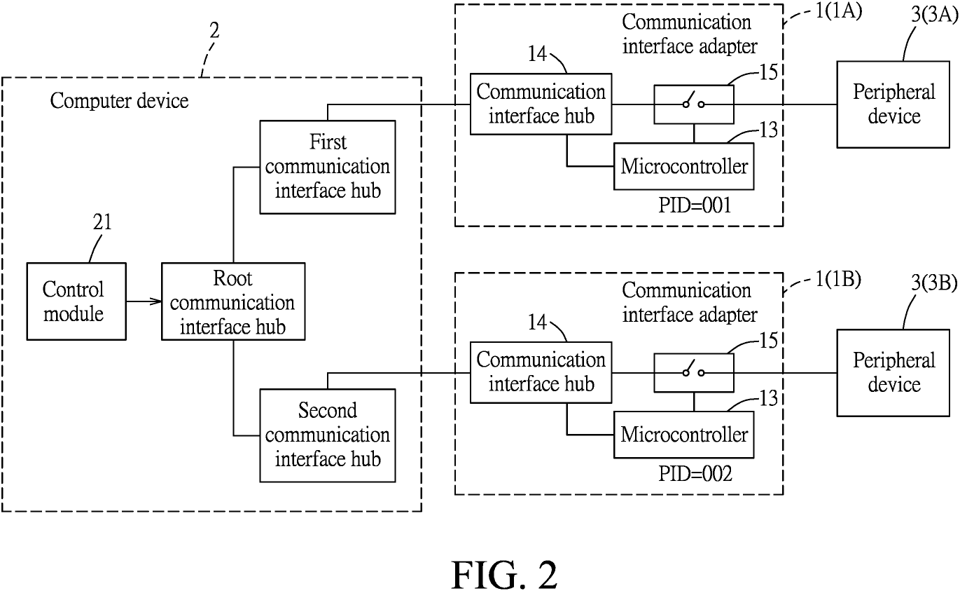

FIG. 2 exemplarily illustrates a case where multiple peripheral devices 3 are electrically connected to the computer device 2 respectively through multiple communication interface adapters 1 of this embodiment. It is noted that the first and second communication interfaces 11, 12 of each of the communication interface adapters 1 are not shown in FIGS. 2 and 4 to 7 for the sake of clarity. In FIG. 2, the peripheral devices 3 are exemplified as a peripheral device 3A and a peripheral device 3B, and the communication interface adapters 1 are exemplified as a communication interface adapter 1A and a communication interface adapter 1B. Each of the peripheral devices 3A, 3B is electrically connected to the corresponding one of the communication interface adapters 1A, 1B that are electrically and respectively connected to a first communication interface hub (e.g., a first USB hub) and a second communication interface hub (e.g., a second USB hub). The first and second communication interface hubs are electrically connected to a root communication interface hub which is controlled by the control module 21. In this embodiment, the first communication interface hub, the second communication interface hub and the root communication interface hub are built in the computer device 2, but this disclosure is not limited in this respect. In this case, the computer device 2 may classify the peripheral device 3A and the microcontroller 13 of the communication interface adapter 1A as devices pertaining to the communication interface hub 14 of the communication interface adapter 1A, and classify the peripheral device 3B and the microcontroller 13 of the communication interface adapter 1B as devices pertaining to the communication interface hub 14 of the communication interface adapter 1B. Since the microcontrollers 13 of the communication interface adapters 1A, 1B are devices pertaining to the communication interface hubs 14 of the communication interface adapters 1A, 1B, which are USB hubs in this embodiment, each of the microcontrollers 13 is assigned a PID (i.e., the controller-stored PID) according to the USB standard.

Assuming that the PIDs stored in the microcontrollers 13 of the communication interface adapters 1A, 1B are “001” and “002”, respectively, when the control module 21 that is included in the application program is operated to control, for example, the peripheral device 3B that is connected to the communication interface adapter 1B to restart, the first control signal generated by the control module 21 should include the reset instruction and the computer-provided PID that is identical to the PID “002” stored in the microcontroller 13 of the communication interface adapter 1B. Upon receipt of the first control signal and upon determining that the computer-provided PID is identical to the controller-stored PID of the communication interface adapter 1B, the microcontroller 13 of the communication interface adapter 1B controls operation of the switch unit 15 of the communication interface adapter 1B based on the reset instruction included in the first control signal to restart the peripheral device 3B.

In practice, the communication interface adapters 1 may be assigned the same PID (e.g., a default PID) during production, so the microcontrollers 13 of the communication interface adapters 1 that are electrically connected to the computer device 2 may have identical PIDs. However, in order to correctly control operation of a specified one of the communication interface adapters 1 that is electrically connected to the computer device 2, each of the controller-stored PIDs of the communication interface adapters 1 should be unique (i.e., the PIDs of devices that are electrically connected to the computer device 2 should be different from each other).

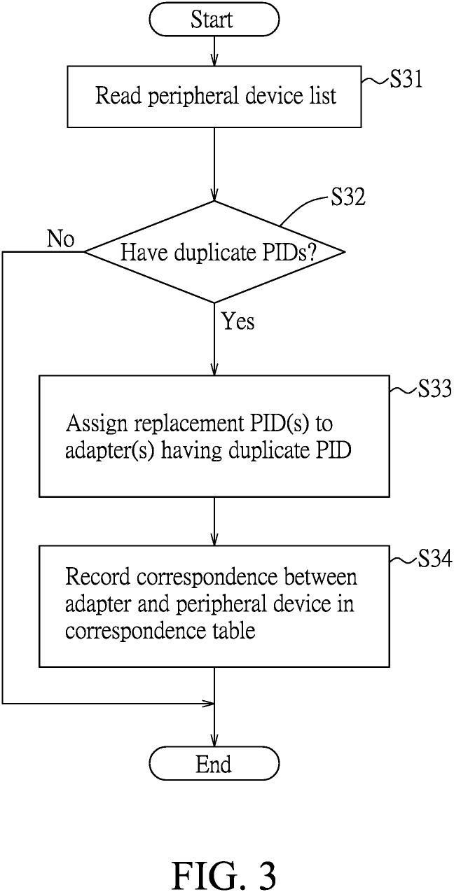

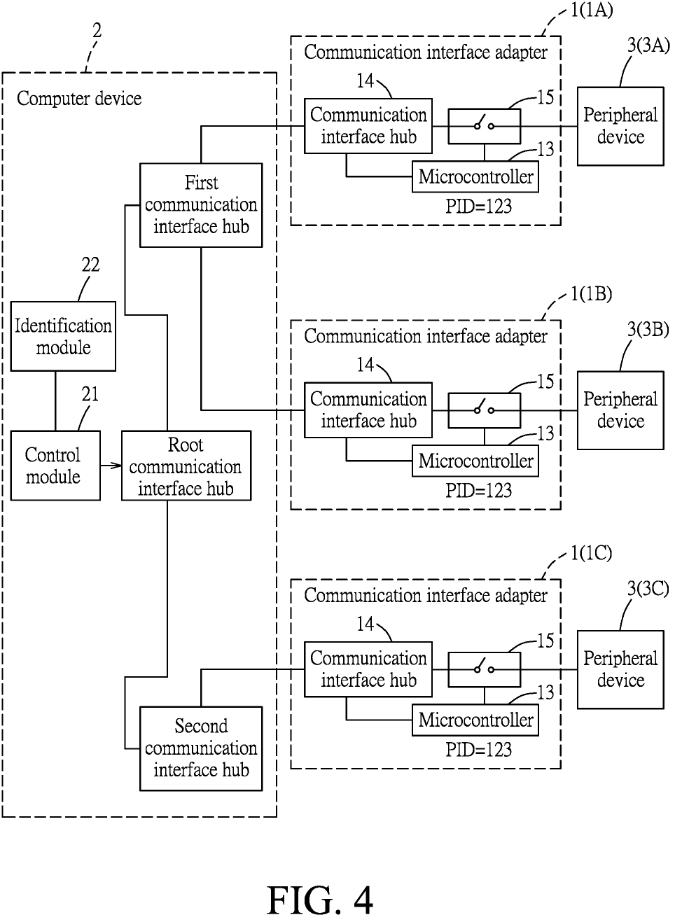

Referring to FIG. 4, in order to ensure that, for each of the communication interface adapters 1 electrically connected to the computer device 2, the PID stored in the microcontroller 13 thereof is unique, the application program may further include an identification module 22 that, when being executed by the computer device 2, causes the computer device 2 to implement a method of dynamic PID assignment. Further referring to FIG. 3, an embodiment of the method of dynamic PID assignment according to this disclosure is illustrated to be adapted for application on the communication interface adapters 1 that have identical PIDs. Usually, when the computer device 2 is powered on, a device that is connected to the computer device 2 will automatically transmit various descriptors that describe its characteristics and required configurations (e.g., device descriptor, configuration descriptor, string descriptor, interface descriptor, endpoint descriptor, device qualifier, other speed configuration, interface power, etc.) to the computer device 2. Specifically, the descriptors include a device descriptor that contains a PID of the device. As exemplified in FIG. 4, after being electrically connected to the computer device 2, each of the communication interface adapters 1A, 1B, 1C will transmit a respective device descriptor to the computer device 2, and the respective device descriptor includes the controller-stored PID of the corresponding one of the communication interface adapters 1A, 1B, 1C. Subsequently, the computer device 2 establishes a peripheral device list according to the descriptors received from all of the devices that are directly (e.g., the communication interface adapters 1A, 1B, 1C) or indirectly (e.g., the peripheral devices 3A, 3B, 3C that are respectively connected to the communication interface adapters 1A, 1B, 1C) connected to the computer device 2. The peripheral device list may contain information of all the devices and their descriptors (including the device descriptors). The computer device 2 further establishes a topology (e.g., a USB topology) that is related to the communication interface and that defines connection relationship among all the devices connected to the computer device 2. Hereinafter, the embodiment of the method of dynamic PID assignment as illustrated in FIG. 3 will be described with reference to the case illustrated in FIG. 4.

In step S31, after the computer device 2 is powered on and establishes the peripheral device list, the identification module 22 automatically reads the peripheral device list stored in the computer device 2, and thus obtains the PIDs (i.e., the controller-stored PIDs) of the communication interface adapters 1A, 1B, 1C based on the peripheral device list.

In step S32, the identification module 22 determines whether some of the PIDs of the communication interface adapters 1A, 1B, 1C are identical. The flow goes to step S33 when the identification module 22 determines that the PIDs of at least two of the communication interface adapters 1 are identical, and ends when otherwise. In FIG. 4, each of the PIDs of the communication interface adapters 1A, 1B, 1C is exemplified to be “123” (i.e., the “at least two of the communication interface adapters 1” include the communication interface adapters 1A, 1B, 1C), so two of the communication interface adapters 1A, 1B, 1C (which are exemplified as the communication interface adapters 1B, 1C in the following descriptions) each need to be assigned a different and unique PID.

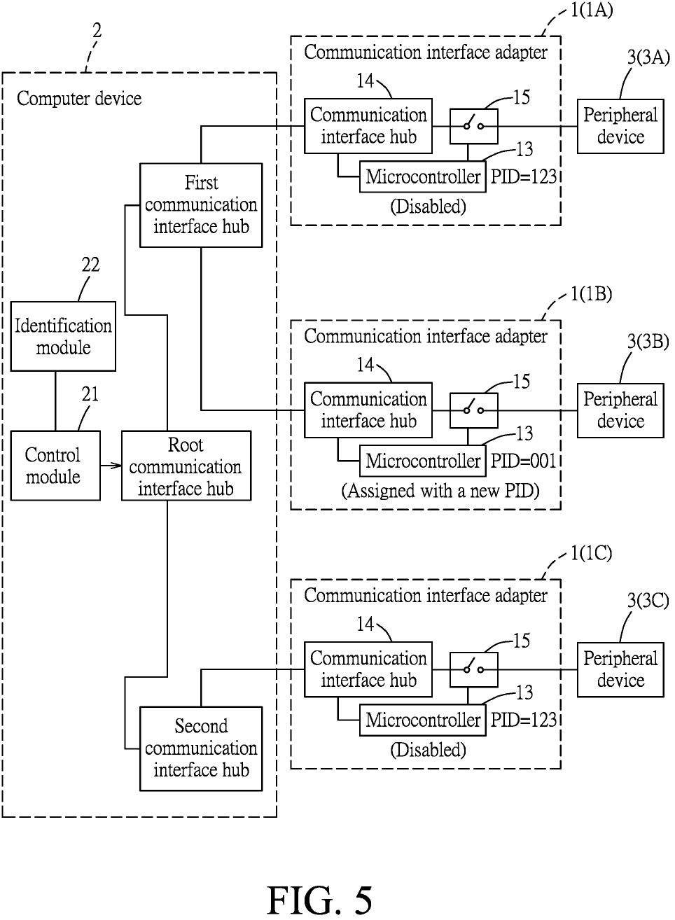

In step S33, the identification module 22 assigns replacement PIDs respectively to the communication interface adapters 1B, 1C, so that each of the communication interface adapters 1B, 1C uses the respective replacement PID to replace the original controller-stored PID, thereby making each of the communication interface adapters 1A, 1B, 1C have a unique PID. In this embodiment, the identification module 22 first assigns a replacement PID, which is different from the PIDs of the communication interface adapters 1A, 1B, 1C, to the communication interface adapter 1B, so as to replace the PID stored in the communication interface adapter 1B with the replacement PID, as shown in FIG. 5. In detail, the identification module 22 disables the communication interface adapters 1A, 1C (i.e., disabling the communication interface adapters 1 except for the communication interface adapter 1B), so the communication interface adapters 1A, 1C are unable to receive any signal from the computer device 2. Then, the identification module 22 generates a replacement PID for the communication interface adapter 1B having at most a predetermined maximum number of bits by either a random manner (e.g., randomly generating the replacement PID that is different from the PIDs of the communication interface adapters 1A, 1C) or a predetermined manner (e.g., generating the replacement PID that is different from the PIDs of the communication interface adapters 1A, 1C based on a predetermined rule, such as selecting a smallest or greatest one of unoccupied PIDs from a series of PIDs starting from “001”, or generating the replacement PID as “124” that is immediately next to the PIDs “123” of the communication interface adapters 1A, 1C). The identification module 22 further determines whether the replacement PID thus generated is identical to any one of the PIDs that have been recorded in the peripheral device list. The identification module 22 may discard the replacement PID when it is determined that the replacement PID thus generated is identical to any one of the PIDs recorded in the peripheral device list, and regenerate another replacement PID until the replacement PID is different from all of the PIDs recorded in the peripheral device list. Herein, the replacement PID for the communication interface adapter 1B is exemplified as “001”, and the identification module 22 transmits, through the control module 21, a second communication interface control signal (referred to as “second control signal” hereinafter) that includes a PID of a target device (i.e., the computer-provided PID, which is identical to the PID “123” of the communication interface adapter 1B herein), a control instruction, and computer-provided data that contains the replacement PID “001”, to the microcontroller 13 of the communication interface adapter 1B. Upon receiving the second control signal and determining that the computer-provided PID is identical to the controller-stored PID of the communication interface adapter 1B (i.e., both being “123” in this case), the microcontroller 13 of the communication interface adapter 1B reads the control instruction and the computer-provided data that contains the replacement PID “001”, and, after confirming that the control instruction requests that a replacement action be performed to replace the controller-stored PID “123” with the replacement PID “001”, the microcontroller 13 of the communication interface adapter 1B stores the replacement PID “001” as the controller-stored PID (i.e., using the replacement PID “001” to replace the controller-stored PID “123”) .

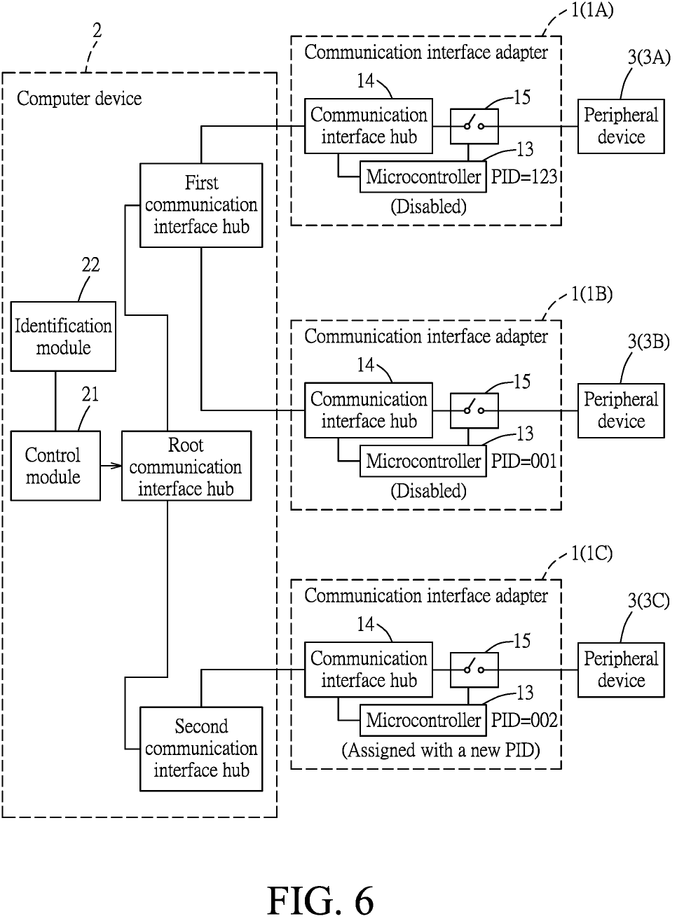

Subsequently, the identification module 22 notifies the control module 21 to disable the microcontrollers 13 of the communication interface adapters 1A, 1B (i.e., disabling the communication interface adapters 1 except for the communication interface adapter 1C), so the communication interface adapters 1A, 1B are unable to receive any signal from the computer device 2. Then, the identification module 22 generates a replacement PID for the communication interface adapter 1C having at most the predetermined maximum number of bits by either the random manner or the predetermined manner. Herein, the replacement PID for the communication interface adapter 1C is exemplified as “002”, and the identification module 22 transmits, through the control module 21, the second control signal that includes a PID of a target device (i.e., the computer-provided PID, which is the same as the PID “123” of the communication interface adapter 1C herein), the control instruction, and computer-provided data that contains the replacement PID “002”, to the microcontroller 13 of the communication interface adapter 1C. Upon receiving the second control signal and determining that the computer-provided PID is identical to the controller-stored PID of the communication interface adapter 1C (i.e., both being “123” in this case), the microcontroller 13 of the communication interface adapter 1C stores the replacement PID “002” as the controller-stored PID (i.e., using the replacement PID “002” to replace the controller-stored PID “123”), as shown in FIG. 6. As a result, the dynamic PID assignment for the communication interface adapters 1 is completed without breaking physical connections between the communication interface adapters 1 and the computer device 2, and each of the communication interface adapters 1A, 1B, 1C thus has a unique PID, and the computer device 2 can thus correctly provide instructions to the microcontroller 13 of a specified one of the communication interface adapters 1 based on the unique PID stored in the communication interface adapter 1.

After the dynamic PID assignment, the operating system of the computer device 2 will find that the controller-stored PIDs of the communication interface adapters 1B, 1C have been changed, and then update the peripheral device list by using the replacement PIDs for the communication interface adapters 1B, 1C to replace the PIDs of the communication interface adapters 1B, 1C contained in the peripheral device list.

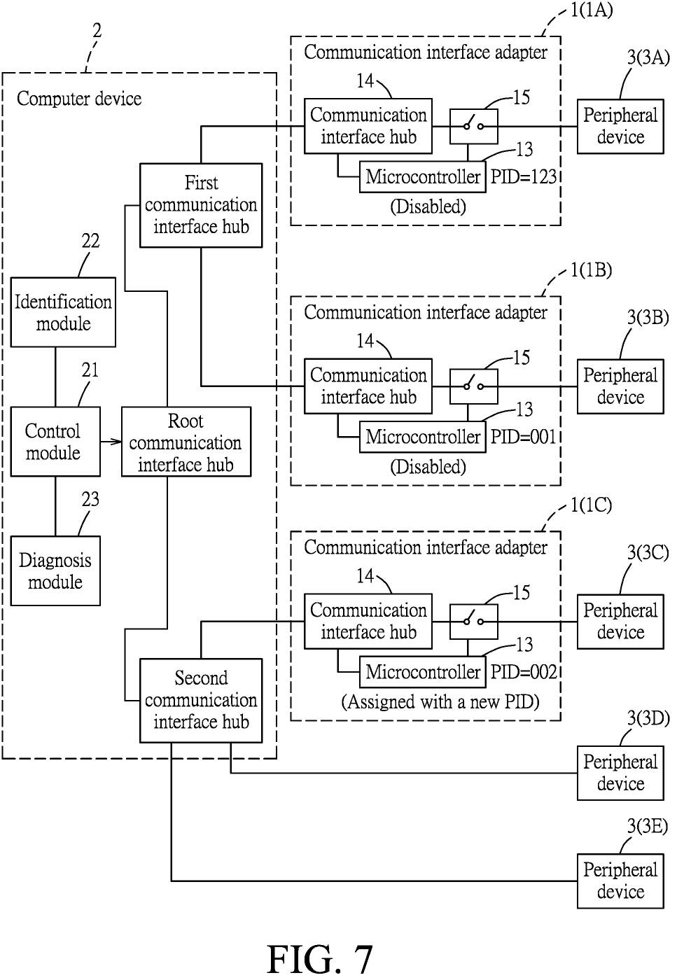

In step S34, the identification module 22 records, based on the peripheral device list thus updated and with respect to each peripheral device 3 that is connected to one of the communication interface adapters 1 (as opposed to a peripheral device 3 that is connected to the computer device 2 without a connection through a communication interface adapter 1), a correspondence between the peripheral device 3 and the communication interface adapter 1 in a correspondence table of the computer device 2. Table 1 illustrates an exemplary correspondence table for a case as shown in FIG. 7, where the microcontroller 13 of the communication interface adapter 1A corresponds to the peripheral device 3A that is electrically connected to the communication interface adapter 1A, the microcontroller 13 of the communication interface adapter 1B corresponds to the peripheral device 3B that is electrically connected to the communication interface adapter 1B, and the microcontroller 13 of the communication interface adapter 1C corresponds to the peripheral device 3C that is electrically connected to the communication interface adapter 1C. In addition, for some other peripheral devices 3D, 3E that are directly connected (i.e., without a connection through a communication interface adapter 1) to the computer device 2 (referred to as directly-connected peripheral devices 3D, 3E), the application program also records, based on the peripheral device list thus updated, each directly-connected peripheral device 3 in the correspondence table.

TABLE 1

| | |
|---|---|
| Adapter | Control target |
| Microcontroller of adapter 1A | Peripheral device 3A |
| Microcontroller of adapter 1B | Peripheral device 3B |
| Microcontroller of adapter 1C | Peripheral device 3C |
| N/A | Peripheral device 3D |
| N/A | Peripheral device 3E |

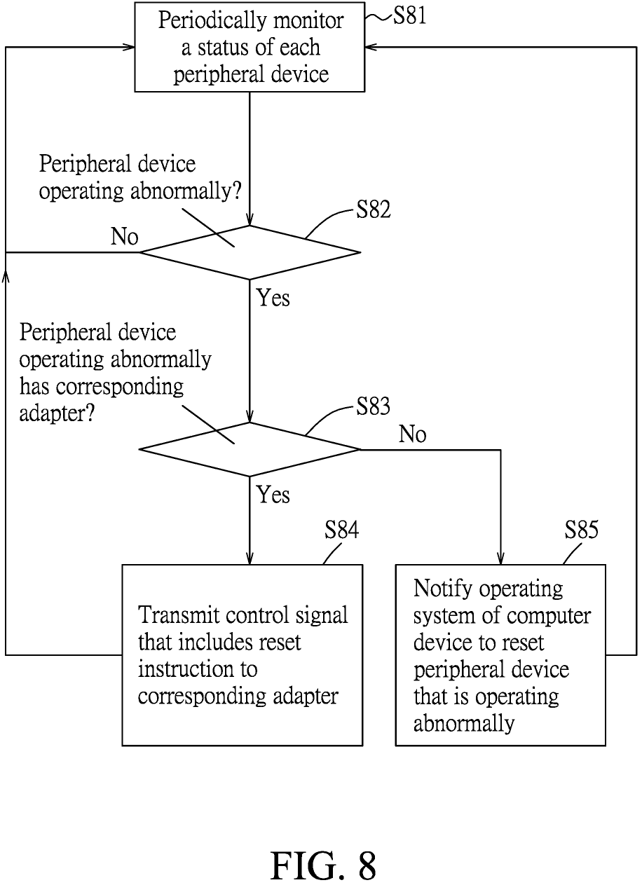

Furthermore, as illustrated in FIG. 7, the application program may further include a diagnosis module 23 that can, when executed by the computer device 2, use the correspondence table (or generate the correspondence table as described above) to perform automatic diagnosis on the peripheral devices 3A, 3B, 3C, 3D, 3E that are directly or indirectly connected to the computer device 2. Further referring to FIG. 8, an embodiment of a method for automatically diagnosing a peripheral device according to this disclosure is provided. The embodiment of the method is also adapted for recovering the peripheral device when the peripheral device is found to be in abnormal operation.

In step S81, the diagnosis module 23 periodically monitors a status of each of the peripheral devices 3 that is recorded in the correspondence table. For example, the diagnosis module 23 may read and detect operation information of the peripheral devices 3 through the operating system of the computer device 2. In step S82, with respect to each of the peripheral devices 3, the diagnosis module 23 determines whether the peripheral device 3 is operating abnormally. For example, the diagnosis module 23 may determine whether the peripheral device 3 cannot be detected, whether the peripheral device 3 cannot be identified, whether an error related to a driver program of the peripheral devices 3 has been detected, whether the peripheral device 3 is operating intermittently, etc. If any one of the abovementioned determinations is affirmative, the diagnosis module 23 determines that the peripheral device 3 is operating abnormally, and the flow goes to step S83 for the peripheral device 3.

In step S83, the diagnosis module 23 determines, based on the correspondence table, whether the peripheral device 3 that is operating abnormally has a corresponding communication interface adapter 1. The flow goes to step S84 when the determination of step S83 is affirmative (e.g., the peripheral device 3 that is operating abnormally is the peripheral device 3B, which has a corresponding communication interface adapter 1B), and goes to step S85 when otherwise, which means that the peripheral device 3 that is operating abnormally is a directly-connected peripheral device, which is exemplified as the peripheral device 3D hereinafter.

In step S84, the diagnosis module 23 finds out, based on the correspondence table, the communication interface adapter 1 that is connected to the peripheral device 3 which is operating abnormally. Hereinafter, the peripheral device 3 that is operating abnormally is exemplified as the peripheral device 3B, and the corresponding one of the communication interface adapters 1 is the communication interface adapters 1B. The diagnosis module 23 obtains the controller-stored PID of the communication interface adapter 1B from the peripheral device list, and transmits, through the control module 21 to the microcontroller 13 of the communication interface adapter 1B, the first control signal that contains the reset instruction and a computer-provided PID identical to the PID of the communication interface adapter 1B as recorded in the peripheral device list.

Upon receiving the first control signal and determining that the computer-provided PID is identical to the controller-stored PID of the communication interface adapter 1B, the microcontroller 13 of the communication interface adapter 1B controls, based on the reset instruction, the peripheral device 3B that is connected to the communication interface adapter 1B and that is operating abnormally to restart, so as to recover the peripheral device 3B.

In step S85, the diagnosis module 23 notifies the operating system of the computer device 2 to use a built-in reset function to reset the directly-connected peripheral device 3D that is operating abnormally, so as to recover the peripheral device 3D to the normal operation state.

In summary, the communication interface adapter 1 that is electrically connected between the computer device 2 and the peripheral device 3 enables the computer device 2 that executes the application program to submit instructions to the microcontroller 13 of the communication interface adapter 1, so as to control operation of the switch unit 15 to restart the peripheral device 3. As a result, the ability of the application program to control the peripheral device 3 is not limited to whether the supplier of the peripheral device 3 has provided a corresponding API for use by the developer of the application program. In addition, the embodiment of this disclosure further provides a method for automatically diagnosing the peripheral device 3, and, when the peripheral device 3 is found to be operating abnormally, the computer device 2 can make the peripheral device 3 perform hardware reset by restarting the peripheral device 3, thereby recovering the peripheral device 3 to the normal operation state.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A communication interface adapter for controlling signal transmission between a computer device and a peripheral device, comprising:
a first communication interface to be electrically connected to the computer device;
a second communication interface to be electrically connected to the peripheral device;
a microcontroller;
a communication interface hub electrically connected to said first communication interface and said microcontroller; and
a switch unit electrically connected between said communication interface hub and said second communication interface, said switch unit being controlled by said microcontroller to make or break connection between said communication interface hub and said second communication interface.

2. The communication interface adapter of claim 1, wherein said microcontroller stores a controller-stored product identification (PID) which is a PID of said communication interface adapter;
wherein said communication interface hub is configured to receive, through said first communication interface, a control signal that includes a computer-provided PID and a reset instruction from the computer device, and to transmit the control signal to said microcontroller;
wherein, upon receiving the control signal and determining that the computer-provided PID is identical to the controller-stored PID, said microcontroller controls operation of said switch unit based on the reset instruction included in the control signal, so as to break the connection between said communication interface hub and said second communication interface and then re-establish said connection in order to restart the peripheral device that is electrically connected to said communication interface adapter.

3. The communication interface adapter of claim 2, wherein said first communication interface has a power terminal, a ground terminal, and at least one data signal terminal;
wherein said second communication interface has a power terminal, a ground terminal and at least one data signal terminal;
wherein said communication interface hub is electrically connected to said power terminal, said ground terminal and said at least one data signal terminal of said second communication interface respectively through a power signal path, a ground signal path and at least one data signal path; and
wherein said switch unit includes a power switch disposed on the power signal path, said power switch being controlled by said microcontroller to make or break signal transmission on the power signal path.

4. The communication interface adapter of claim 3, wherein said first communication interface, said communication interface hub, the power signal path and said second communication interface are configured to cooperatively transmit a power signal that is outputted by the computer device to the peripheral device when said power switch is in a conducting state; and
wherein, upon determining that the reset instruction requests that a reset action be performed with respect to the power signal, said microcontroller turns said power switch off and then on, so that the power signal provided to the peripheral device is temporarily interrupted and then recovered for restarting the peripheral device.

5. The communication interface adapter of claim 3, wherein said switch unit further includes at least one data signal switch disposed on the at least one data signal path;
wherein said at least one data signal switch is controlled by said microcontroller to make or break signal transmission on the at least one data signal path;
wherein said first communication interface, said communication interface hub, the at least one data signal path and said second communication interface are configured to cooperatively transmit a communication interface signal that is outputted by the computer device to the peripheral device when the at least one data signal switch is in a conducting state; and
wherein, upon determining that the reset instruction requests that a reset action be performed with respect to the communication interface signal, said microcontroller turns said at least one data signal switch off and then on, so as to restart the peripheral device, and make the peripheral device receive the communication interface signal through the at least one data signal path again.

6. The communication interface adapter of claim 1, wherein said microcontroller stores a controller-stored product identification (PID) which is a PID of said communication interface adapter;
wherein said communication interface hub is configured to receive, through said first communication interface from the computer device, a communication interface control signal that includes a computer-provided PID, a control instruction and computer-provided data, and to transmit the communication interface control signal to said microcontroller, wherein the computer-provided data includes a replacement PID;
wherein, upon receiving the communication interface control signal and determining that the computer-provided PID is identical to the controller-stored PID, said microcontroller reads the replacement PID contained in the computer-provided data and the control instruction;
wherein, upon determining that the control instruction requests that a replacement action be performed to replace the controller-stored PID with the replacement PID, said microcontroller stores the replacement PID and uses the replacement PID to replace the controller-stored PID.

7. The communication interface adapter of claim 5, wherein, upon detecting that the computer device is electrically connected to said first communication interface, said microcontroller automatically controls said power switch and said at least one data signal switch to be in the conducting state.

8. The communication interface adapter of claim 5, wherein said microcontroller has a monitoring mechanism that is configured to, upon detecting that a main program that is being executed by said microcontroller has an error, make said microcontroller restart, so that said microcontroller recovers to a normal operation state; and
wherein said microcontroller is configured to automatically control said power switch and said at least one data signal switch to be in the conducting state when said microcontroller restarts.

9. The communication interface adapter of claim 1, wherein the peripheral device is a universal serial bus (USB) peripheral device, said communication interface adapter is a USB adapter, said first communication interface is a first USB connector, said second communication interface is a second USB connector, and said communication interface hub is a USB hub.

10. A method of dynamic product identification (PID) assignment, comprising steps of:
providing a plurality of communication interface adapters connected to a computer device, each of the communication interface adapters including:
a first communication interface electrically connected to the computer device;
a second communication interface electrically connected to a peripheral device;
a microcontroller storing a PID of the communication interface adapter;
a communication interface hub electrically connected to the first communication interface and the microcontroller; and
a switch unit electrically connected between the communication interface hub and the second communication interface, the switch unit being controlled by the microcontroller to make or break connection between the communication interface hub and the second communication interface;
by the computer device, reading a peripheral device list that is stored in the computer device, the peripheral device list containing the PID of each of the communication interface adapters;
by an identification module of the computer device, obtaining the PIDs of the communication interface adapters based on the peripheral device list, and, upon determining that the PIDs of at least two of the communication interface adapters are identical, assigning a replacement PID which is different from the PIDs of said the communication interface adapters, to one of the at least two of the communication interface adapters through a control module executed by the computer device, so as to replace the PID stored in said one of the at least two of the communication interface adapters with the replacement PID;
by the computer device, updating the peripheral device list by using the replacement PID to replace the PID of said one of the at least two of the communication interface adapters contained in the peripheral device list; and
by the identification module, recording, based on the peripheral device list thus updated and with respect to each peripheral device among those of the peripheral devices that are each connected to one of the communication interface adapters, a correspondence between the peripheral device and the communication interface adapter in a correspondence table of the computer device.

11. The method of claim 10, wherein the at least two of the communication interface adapters include a first communication interface adapter and a second communication interface adapter, and the step of assigning the replacement PID includes:
disabling the at least two of the communication interface adapters except for the first communication interface adapter;
generating the replacement PID; and
providing the replacement PID to the first communication interface adapter, so that the PID stored in the first communication interface adapter is replaced by the replacement PID.

12. The method of claim 11, wherein the at least two of the communication interface adapters further include a third communication interface adapter;
said method further comprising, after the PID stored in the first communication interface adapter is replaced by the replacement PID, steps of:
disabling the at least two of the communication interface adapters except for the second communication interface adapter;
generating another replacement PID that is different from the PIDs of the communication interface adapters; and
providing said another replacement PID to the second communication interface adapter, so that the PID stored in the second communication interface adapter is replaced by said another replacement PID.

13. The method of claim 10, further comprising a step of, by the identification module, recording, based on the peripheral device list thus updated, each directly-connected peripheral device that is connected to the computer device without connection through a communication interface adapter in the correspondence table.

14. The method of claim 10, wherein the step of updating the peripheral device list is performed upon the computer device finding that the PID of said one of the at least two of the communication interface adapters is changed.

15. A method for automatically diagnosing a peripheral device and, when the peripheral device is found to be in abnormal operation, recovering the peripheral device, comprising:
providing a plurality of communication interface adapters connected to a computer device, each of the communication interface adapters including:
a first communication interface electrically connected to the computer device;
a second communication interface electrically connected to a peripheral device;
a microcontroller storing a product identification (PID) of the communication interface adapter;
a communication interface hub electrically connected to the first communication interface and the microcontroller; and
a switch unit electrically connected between the communication interface hub and the second communication interface, the switch unit being controlled by the microcontroller to make or break connection between the communication interface hub and the second communication interface;
by the computer device, reading a peripheral device list that is stored in the computer device, wherein the peripheral device list contains the PIDs of the communication interface adapters, and device information of the peripheral devices that are connected to the communication interface adapters;
by the computer device, establishing a correspondence table that records, for each of the communication interface adapters, a correspondence between the communication interface adapter and the peripheral device that is connected to the communication interface adapter;
by a diagnosis module of the computer device, periodically monitoring a status of each of the peripheral devices that is recorded in the correspondence table;
upon determining that one of the peripheral devices is operating abnormally, by the diagnosis module, finding out, based on the correspondence table, one of the communication interface adapters that is connected to the peripheral device which is operating abnormally, and transmitting, through a control module executed by the computer device to said one of the communication interface adapters, a control signal that includes a reset instruction and a computer-provided PID identical to the PID of said one of the communication interface adapters; and
upon receiving the control signal and determining that the computer-provided PID is identical to the PID stored in said one of the communication interface adapters, by said one of the communication interface adapters, controlling, based on the reset instruction, the peripheral device that is connected to said one of the communication interface adapters and that is operating abnormally to restart.

16. The method of claim 15, wherein the correspondence table further records information of a directly-connected peripheral device that is connected to the computer device without a connection through a communication interface adapter;
said method further comprising a step of:
upon determining that the directly-connected peripheral device is operating abnormally, by the diagnosis module, notifying an operating system of the computer device to use a reset function of a built-in software program to reset the directly-connected peripheral device that is operating abnormally.
